(19) United States
(12) Patent Application Publication
(10) Pub. No.: US 2025/0119667 A1
(43) Pub. Date: Apr. 10, 2025

(54) AD CONVERSION CIRCUIT AND SOLID-STATE IMAGING DEVICE

(71) Applicant: Samsung Electronics Co., Ltd., Suwon-si (KR)

(72) Inventor: Yoshiharu KUDO, Yokohama (JP)

(73) Assignee: Samsung Electronics Co., Ltd., Suwon-si (KR)

(21) Appl. No.: 18/884,572

(22) Filed: Sep. 13, 2024

(30) Foreign Application Priority Data
Oct. 5, 2023 (JP) 2023-173706
May 28, 2024 (KR) 10-2024-0069523

(51) Int. Cl. H04N 25/78; H04N 25/42; H04N 25/76; H04N 25/772

(52) U.S. Cl. CPC H04N 25/78; H04N 25/42; H04N 25/772; H04N 25/7795

(57) ABSTRACT

A single-slope analog-digital (AD) conversion circuit for performing AD conversion on a pixel signal includes a plurality of comparators configured to receive a plurality of pixel signals and a ramp signal, a count pulse controller configured to generate a counter input signal for counting an average value or a weighted average value of the plurality of pixel signals from a clock signal, based on outputs of the plurality of comparators, and a counter configured to count the average value or the weighted average value of the plurality of pixel signals based on the counter input signal.

### CROSS-REFERENCE TO RELATED APPLICATION

This application is based on and claims priority under 35 U.S.C. § 119 to Japanese Patent Application No. 2023-173706, filed on Oct. 5, 2023, in the Japanese Patent Office and Korean Patent Application No. 10-2024-0069523, filed on May 28, 2024, in the Korean Intellectual Property Office, the disclosures of which are incorporated by reference herein in their entirety.

### BACKGROUND

The inventive concepts relate to analog-digital (AD) conversion circuits and solid-state imaging devices.

A solid-state imaging device may receive light incident from a subject and may generate an electrical signal by photoelectrically converting the received light. For example, the solid-state imaging device may be an image sensor. The solid-state imaging device may include an analog-to-digital converter (ADC) circuit corresponding to each column of a pixel array. Hereinafter, the ADC circuit may be referred to as an analog-digital (AD) conversion circuit.

In a solid-state imaging device, a column-parallel conversion method of performing analog-digital conversion (hereinafter, referred to as AD conversion) on pixel signals read from pixels included in one row within a horizontal scanning period at once is used. Also, a single-slope AD conversion circuit may be used as an AD conversion circuit.

To ensure sensitivity, a solid-state imaging device may perform a binning operation in which a plurality of pixels are collected and regarded as one pixel by adding and averaging signals of the plurality of pixels. Due to the binning operation, resolution may decrease but sensitivity may increase. The binning operation includes analog signal addition or digital signal addition.

A method of analog signal addition includes a method in which pixel signals output from source followers of pixels are added as analog signals by directly connecting signal lines of outputs of the source followers. In this method, due to characteristics of source followers, a plurality of transistors of the source followers are connected in parallel and a current source is shared by a plurality of source followers. Accordingly, current may concentrate on a transistor having a higher input voltage from among the plurality of transistors connected in parallel, and current flowing through other transistors may decrease. Accordingly, current of the source followers which should operate with constant current does not become constant, thereby failing to ensure linearity.

Another method of analog signal addition includes a method in which pixel signals of pixels are input in parallel to an input of an AD conversion circuit. The input of the AD conversion circuit may be connected to a signal line from each pixel through capacitive coupling In this method, pixel signals are added and averaged as analog signals by connecting capacitors used for capacitive coupling in parallel at the input of the AD conversion circuit. In this method, because a current source is provided for each source follower, linearity may be ensured, but the number of signal lines connected to the input of the AD conversion circuit may increase. The AD conversion circuit is provided in units of columns and laid out outside one side of a pixel array. Accordingly, the wiring of signal lines may become longer, a layout may be complicated, and interference between signal lines may occur.

On the other hand, digital signal addition involves adding and averaging pixel signals through calculation after digital conversion by an ADC. Accordingly, a chip area and power consumption may increase, and a processing speed may decrease due to the calculation.

### SUMMARY

The inventive concepts provide analog-digital (AD) conversion circuits and solid-state imaging devices which generate a counter input signal for counting an average value or a weighted average value of a plurality of pixel signals from a clock signal and perform a pixel signal binning operation by counting an average value or a weighted average value of a plurality of pixel signals based on the counter input signal. That is, the inventive concepts provide AD conversion circuits and solid-state imaging devices which may perform pixel signal binning with high precision while suppressing layout complexity, an increase in chip area, an increase in power consumption, and a decrease in processing speed.

According to some aspects of the inventive concepts, an analog-digital (AD) conversion circuit for performing AD conversion on a pixel signal includes a plurality of comparators configured to receive a plurality of pixel signals and a ramp signal, a count pulse controller configured to generate a counter input signal for counting an average value or a weighted average value of the plurality of pixel signals from a clock signal, based on outputs of the plurality of comparators, and a counter configured to count the average value or the weighted average value of the plurality of pixel signals based on the counter input signal.

According to some aspects of the inventive concepts, a solid-state imaging device includes a plurality of comparators configured to receive a plurality of pixel signals and a ramp signal, a count pulse controller configured to generate a counter input signal for counting an average value or a weighted average value of the plurality of pixel signals from a clock signal, based on outputs of the plurality of comparators, a counter configured to count the average value or the weighted average value of the plurality of pixel signals based on the counter input signal, and a plurality of coupling capacitors respectively connected to inputs of the plurality of comparators to which the plurality of pixel signals are input, wherein the count pulse controller is further configured to generate the counter input signal for counting the weighted average value of the plurality of pixel signals, wherein weights are assigned to the plurality of pixel signals according to a ratio of capacitance values of the plurality of coupling capacitors to assign a weight to the weighted average value.

According to some aspects of the inventive concepts, a solid-state imaging device includes a plurality of comparators configured to receive a plurality of pixel signals and a ramp signal, a count pulse controller configured to generate a counter input signal for counting an average value or a weighted average value of the plurality of pixel signals from a clock signal, based on outputs of the plurality of comparators, a counter configured to count the average value or the weighted average value of the plurality of pixel signals based on the counter input signal, and a ramp signal generator configured to generate a plurality of ramp signals with ramp signals whose slopes have different gradients and respectively input the plurality of ramp signals to the plurality of comparators, wherein the count pulse controller is further configured to generate the counter input signal for counting the weighted average value of the plurality of pixel signals, wherein weights are assigned to the plurality of pixel signals according to gradients of the slopes of the plurality of ramp signals to assign a weight to the weighted average value.

### BRIEF DESCRIPTION OF THE DRAWINGS

Embodiments will be more clearly understood from the following detailed description taken in conjunction with the accompanying drawings in which:

FIG. 1 is a diagram illustrating a configuration of a solid-state imaging device, according to some example embodiments;

FIG. 2 is a diagram illustrating a configuration of a pixel, according to some example embodiments;

FIG. 3 is a diagram illustrating a timing chart of a pixel signal read and analog-digital (AD) conversion operation, according to some example embodiments;

FIG. 4 is a diagram for describing a binning mode, according to some example embodiments;

FIG. 5 is a diagram for describing a binning mode, according to some example embodiments;

FIG. 6 is a diagram for describing a comparator and a counter circuit unit, according to some example embodiments;

FIG. 7 is a diagram illustrating a configuration example of a count pulse controller and a truth table, according to some example embodiments;

FIG. 8 is a graph showing a relationship between an operation time of an analog-to-digital conversion (ADC) circuit and a count value by a counter, according to some example embodiments;

FIG. 9 is a diagram illustrating a timing chart of the count pulse controller of FIG. 7, according to some example embodiments;

FIG. 10 is a diagram for describing an example of counting a weighted average value in binning, according to some example embodiments;

FIG. 11 is a diagram for describing some example embodiments of adjusting a gradient of a ramp signal Vref, according to some example embodiments;

FIG. 12 is a diagram for describing a count pulse controller, according to some example embodiments;

FIG. 13 is a diagram illustrating a timing chart of the count pulse controller of FIG. 12;

FIG. 14 is a diagram for describing a count pulse controller for binning pixel signals of four pixels in the same row, according to some example embodiments;

FIG. 15 is a diagram illustrating a timing chart of four types of clock signals CLK1, CLK2, CLK3, and CLK3 input to the count pulse controller of FIG. 14;

FIG. 16 is a diagram illustrating a configuration of a count pulse controller for binning pixel signals of two pixels in the same row, according to some example embodiments;

FIG. 17 is a diagram illustrating a timing chart of the count pulse controller of FIG. 16;

FIG. 18 is a diagram illustrating a configuration of a comparator and a counter circuit unit, according to some example embodiments;

FIG. 19 is a diagram illustrating a part of a pixel array, according to some example embodiments;

FIG. 20 is a diagram illustrating a configuration of a comparator and a counter circuit unit, according to some example embodiments;

FIG. 21 is a diagram illustrating a part of a pixel array, according to some example embodiments;

FIG. 22 is a diagram for describing a read timing of a pixel signal, according to some example embodiments;

FIG. 23 is a diagram illustrating a circuit configuration for performing binning of counting a weighted average value of pixel signals of a plurality of pixels, according to some example embodiments;

FIG. 24 is a diagram for describing a timing of reading pixel signals and counting an average value of pixels, according to some example embodiments;

FIG. 25 is a diagram illustrating a configuration of an AD conversion circuit for counting an average value of pixel signals, according to a comparative example;

FIG. 26 is a graph showing linearity characteristics in pixel signal addition, in the AD conversion circuit of FIG. 25; and

FIG. 27 is a diagram illustrating a configuration of an AD conversion circuit for counting an average value of pixel signals, according to another comparative example.

### DETAILED DESCRIPTION

Hereinafter, an analog-digital (AD) conversion circuit and a solid-state imaging device according to some example embodiments will be described in detail with reference to the attached drawings. The example embodiments described below are merely examples, and various modifications may be made from the example embodiments. The same elements are denoted by the same reference numerals in the drawings, and thus, a repeated description thereof will be omitted. Sizes of elements in the drawings may be exaggerated for convenience of explanation and clarity.

Hereinafter, what is referred to as “above” or “on” may include not only being in contact with the top/bottom/left/right but also being in non-contact with the top/bottom/left/right.

While such terms as “first,” “second,” etc., may be used to describe various components, the above terms are used only to distinguish one component from another. There terms do not limit that materials or structures of elements are different from each other.

The singular forms “a,” “an,” and “the” are intended to include the plural forms as well, unless the context clearly indicates otherwise. In addition, when a part “includes” a certain element, the part may further include another element instead of excluding the other element, unless otherwise stated.

Also, the term used in some example embodiments such as “ . . . unit” or “ . . . module” refers to a unit for processing one or more functions or operations, and the unit is implemented in hardware, software, or in a combination of hardware and software.

Also, the terms “row” and “column” each simply refer to a direction in which pixels, etc. are arranged, and the terms “row” and “column” may be interchangeably used.

Also, “simultaneous” includes not only a case where events occur at exactly the same time but also a case where, although based on control intended to be “simultaneous”, events do not occur at exactly the same time due to element non-uniformity or the influence of parasitic elements.

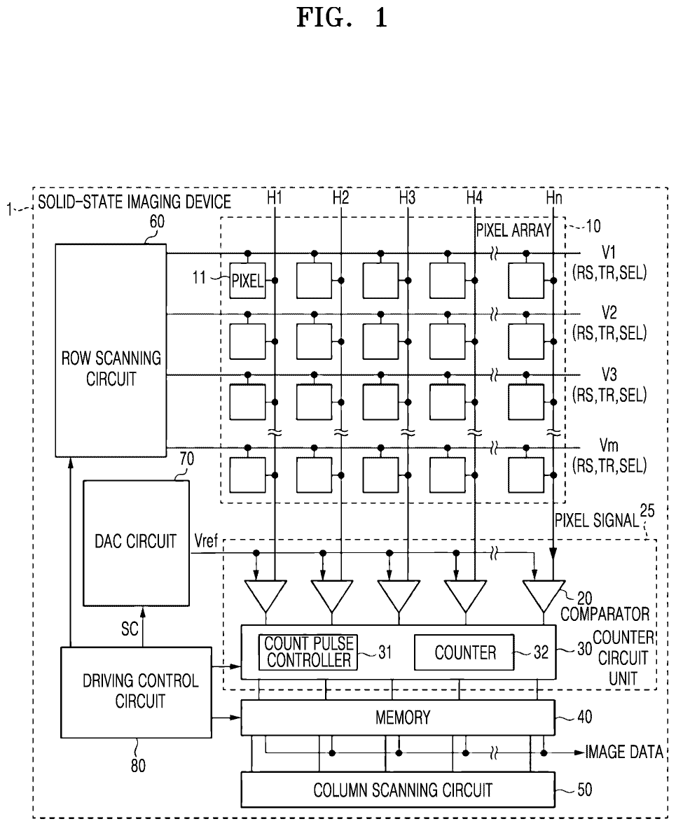

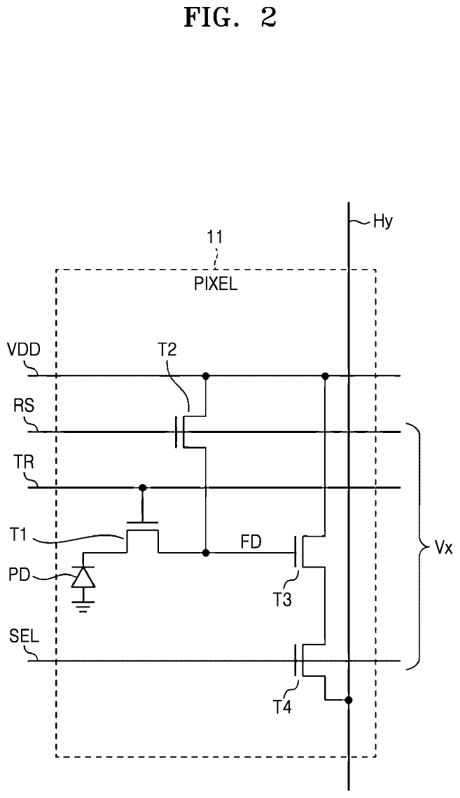

FIG. 1 is a diagram illustrating a configuration of a solid-state imaging device 1, according to some example embodiments. FIG. 2 is a diagram illustrating a configuration of a pixel 11, according to some example embodiments.

Referring to FIG. 1, the solid-state imaging device 1 may include a pixel array 10, a comparator 20, a counter circuit unit 30, a memory 40, a column scanning circuit 50, a row scanning circuit 60, a digital-to-analog converter (DAC) circuit 70, and a driving control circuit 80. The comparator 20 and the counter circuit unit 30 may constitute an analog-to-digital converter (ADC) circuit 25. The ADC circuit 25 may constitute a single-slope AD conversion circuit. The solid-state imaging device 1 may include more elements than those illustrated in FIG. 1 when necessary.

The pixel array 10 may include a plurality of pixels 11 arranged in rows and columns.

Referring to FIGS. 2 and 1 together, the pixel 11 may include a photodiode PD, a transmission transistor T1, a reset transistor T2, an amplification transistor T3, and a selection transistor T4.

In some example embodiments, at least one of the comparator 20, the counter circuit unit 30, the memory 40, the column scanning circuit 50, the row scanning circuit 60, the DAC circuit 70, and the driving control circuit 80 may be located outside the pixel array 10.

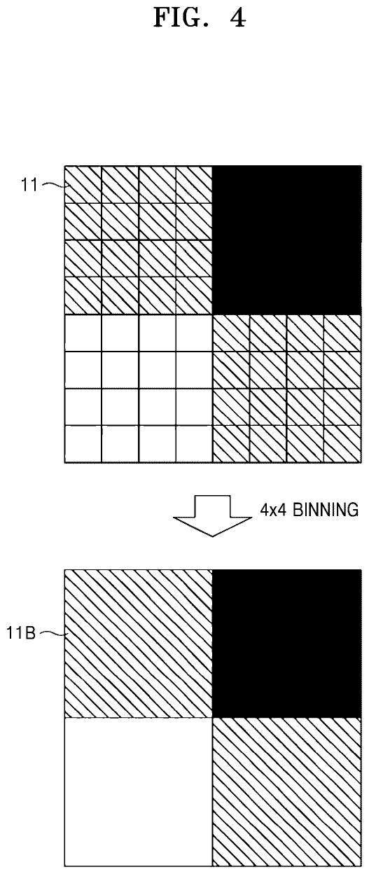

The solid-state imaging device 1 may operate in a binning mode in which a plurality of pixels are collected and regarded as one pixel by adding and averaging signals of the plurality of pixels and a normal mode in which such addition and averaging are not performed. The solid-state imaging device 1 may perform a function of switching between the binning mode and the normal mode. Hereinafter, the normal mode and the binning mode will be described in this order. The normal mode will be described with reference to FIGS. 1 to 3, and the binning mode will be described with reference to FIG. 4.

In the normal mode, row control lines V1 to Vm controlled by the row scanning circuit 60 are connected to the pixels 11. The row control lines V1 to Vm transmit a control signal for selecting the pixel 11 for reading a pixel signal for each row. A reset signal line RS, a read signal line TR, and a selection signal line SEL may be included in each of the row control lines V1 to Vm. The selection signal line SEL transmits a control signal for selecting the pixel 11 for reading a pixel signal. The read signal line TR transmits a control signal for outputting a voltage (output voltage) of the photodiode PD to a floating diffusion node FD. The reset signal line RS transmits a control signal for resetting a voltage of the floating diffusion node FD.

Column signal lines H1 to Hn for transmitting a pixel signal output (read) from the pixel 11 to the comparator 20 for each column may be connected to the pixels 11.

The driving control circuit 80 may control an overall operation of the solid-state imaging device 1. The driving control circuit 80 may receive control data for timing setting or a master clock signal from an external device such as a digital signal processor (DSP). The driving control circuit 80 may generate various clock signals and may output the clock signals to control the solid-state imaging device 1. For example, the driving control circuit 80 may control the row scanning circuit 60, the DAC circuit 70, the counter circuit unit 30, and the memory 40.

The row scanning circuit 60 generates and outputs a control signal for selecting the pixel 11 for reading a pixel signal for each row through the row control lines V1 to Vm. A pixel signal is output from each pixel 11 of one row selected by the control signal and is input to the comparator 20 through each of the column signal lines H1 to Hn.

The DAC circuit 70 generates and outputs a ramp signal Vref based on a control signal SC for generating the ramp signal Vref. The ramp signal Vref is a voltage that decreases in proportion to time. In detail, the ramp signal Vref may decrease in proportion to the number of clock signals.

The comparator 20 compares a pixel signal transmitted through the column signal lines H1 to Hn with the ramp signal Vref and outputs a comparison result. For example, the comparator 20 may compare a voltage of a pixel signal with a voltage of the ramp signal Vref and may output a comparison result. For example, the comparator 20 may output a logic high level when a pixel signal is lower than the ramp signal Vref and outputs a logic low level when a pixel signal is higher than the ramp signal Vref. However, the inventive concepts are not limited thereto.

The counter circuit unit 30 includes a count pulse controller 31 and a counter 32. The count pulse controller 31 may operate only in the binning mode described below. The counter 32 counts a clock signal CLK until the ramp signal Vref is lower than a pixel signal by using the clock signal CLK at the same time as the ramp signal Vref input to the comparator 20 starts to be output, and outputs a counting result. The clock signal CLK may be included in various clock signals generated by the driving control circuit 80.

A pixel signal is AD converted for each column of one row due to the above operation of the comparator 20 and the counter 32.

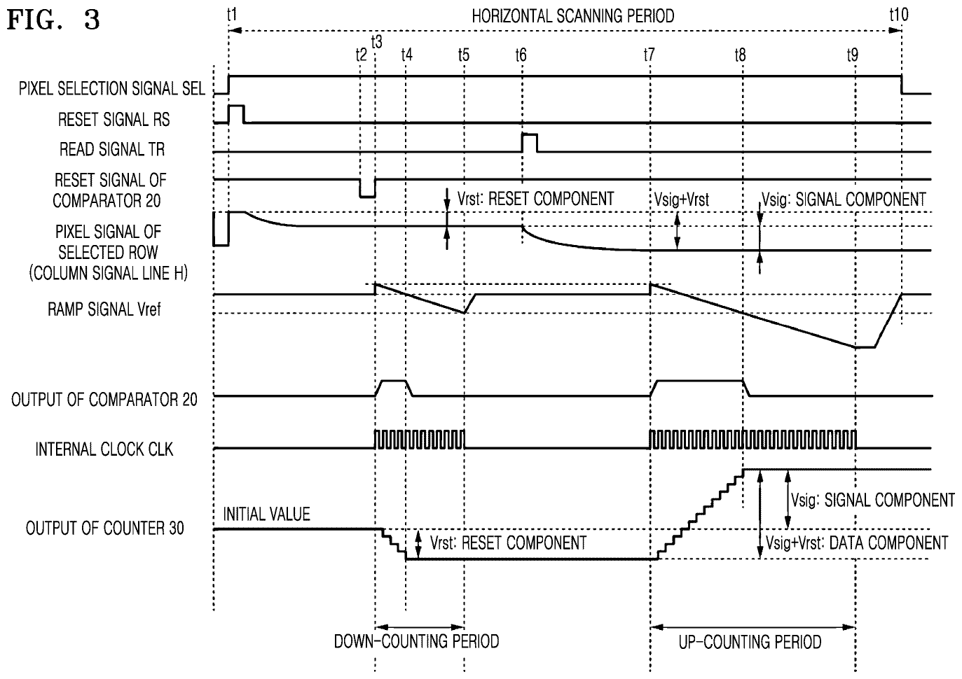

The memory 40 stores a counting result, which is the pixel signal after AD conversion, for each pixel 11. As described below, a voltage (e.g., a reset component Vrst) output from the pixel 11 immediately after a voltage of the floating diffusion node FD is reset by a reset signal transmitted through the reset signal line RS is AD converted and is subtracted from the counting result. Accordingly, a pixel signal (e.g., a signal component Vsig of FIG. 3) from which the influence of noise or the like is removed may be obtained.

The column scanning circuit 50 may output image data. For example, the column scanning circuit 50 may read counting results of pixel signals stored for each pixel 11 in the memory 40, may integrate them in units of frames, and may output them as image data.

FIG. 3 is a diagram illustrating a timing chart of a pixel signal read and AD conversion operation, according to some example embodiments. The following will be described with reference to FIGS. 1, 2, and 3 together. FIG. 3 illustrates a timing chart of a pixel signal (voltage) read and AD conversion operation for the pixel 11 connected to a selected row control line Vx. The selected row control line may be one row control line selected from among the row control lines V1 to Vm of FIG. 1.

At a time t1, the driving control circuit 80 may turn on the selection transistor T4 of the pixel 11 by setting a level of the selection signal line SEL to a logic high level to select a plurality of pixels 11 connected to one row control line Vx.

In a state where the transmission transistor Tl is turned off by setting the read signal line TR to a logic low level, the driving control circuit 80 may turn on the reset transistor T2 by setting the reset signal line Rs to a logic high level. Accordingly, a voltage of the floating diffusion node FD may be reset.

Next, the driving control circuit 80 may turn off the reset transistor by setting the reset signal line RS to a logic low level after a certain time elapses.

At a time t2, the driving control circuit 80 causes the comparator 20 to be initialized by a reset signal of the comparator 20. The reset signal of the comparator 20 at the time t2 may be at a logic low level, and may be maintained at the logic low level until a time t3. The comparator 20 may be initialized from the time t2 to the time t3.

At the time t3, the driving control circuit 80 may release the initialization of the comparator 20 by the reset signal of the comparator 20, and the DAC circuit 70 may set a ramp signal Vref as a starting voltage and may initialize an output of the comparator 20 to a logic high level (initial value).

The driving control circuit 80 may provide a clock signal CLK to the counter circuit unit 30 and the DAC circuit 70. The comparator 20 compares the ramp signal Vref with a reset component Vrst of the pixel output to each of the column signal lines H1 to Hn, and the counter circuit unit 30 starts down-counting from the initial value (e.g., a reset value 0).

The comparator 20 may invert an output from a logic high level to a logic low level when the ramp signal Vref is the same as the reset component Vrst of the pixel 11 of the Vx row input through the column signal lines H1 to Hn. For example, the comparator 20 may change an output of the comparator 20 from a logic low level to a logic high level from the time t3, and may change an output from a logic high level to a logic low level from a time t4.

The solid-state imaging device 1 may compare the reset component Vrst with the ramp signal Vref and may count a value corresponding to a size of the reset component Vrst by using the clock signal CLK, to obtain a count value corresponding to the size of the reset component Vrst.

When a certain down-counting period elapses, the driving control circuit 80 stops supplying a signal such as the ramp signal Vref to the comparator 20 and supplying the clock signal CLK to the DAC circuit 70 and the counter circuit unit 30. For example, from a time t5, the driving control circuit 80 may stop supplying a signal such as the ramp signal Vref to the comparator 20 and supplying the clock signal CLK to the DAC circuit 70 and the counter circuit unit 30.

Next, at a time t6, the driving control circuit 80 may turn on the transmission transistor t1 by setting the read signal line TR to a logic high level. Accordingly, photocharges accumulated in the photodiode PD are transferred to the floating diffusion node FD. Next, the driving control circuit 80 may turn off the transmission transistor T1 by setting the read signal line TR to a logic low level.

At a time t7, the DAC circuit 70 sets the ramp signal Vref as a starting voltage again and initializes an output of the comparator 20 to a logic high level.

Next, the driving control circuit 80 supplies the clock signal CLK to the counter circuit unit 30 and the DAC circuit 70. The comparator 20 may compare the ramp signal Vref with a read data component Vrst+Vsig output to each of the column signal lines H1 to Hn. That is, the counter circuit unit 30 starts up-counting from the count value (output of the counter 30) at which the down-counting is stopped.

The comparator 20 may invert an output of the comparator 20 from a logic high level to a logic low level when the ramp signal Vref is the same as the read data component Vrst+Vsig of the pixel 11 of the Vx row input through the column signal lines H1 to Hn. For example, an output of the comparator 20 may change from a logic low level to a logic high level from the time t7, and may change from a logic high level to a logic low level from a time t8. Accordingly, the read data component Vrst+Vsig and the ramp signal Vref may be compared, and a value corresponding to a size of the read data component Vrst+Vsig may be counted by using the clock signal CLK. Because up-counting starts from the count value at which the down-counting is stopped, a count value of a signal component Vsig obtained by subtracting the reset signal Vrst from the read data component Vrst+Vsig may be obtained as an output of the counter circuit unit 30.

When a certain up-counting period elapses, the driving control circuit 80 stops supplying a signal such as the ramp signal Vref to the comparator 20 and supplying the clock signal CLK to the DAC circuit 70 and the counter circuit unit 30. For example, from a time t9 when the up-counting period elapses, the driving control circuit 80 may stop supplying a signal such as ramp signal Vref to the comparator 20 and supplying the clock signal CLK to the DAC circuit 70 and the counter circuit unit 30.

Next, at a time t10, the driving control circuit 80 may turn off the selection transistor T4 of the pixel 11 by setting a level of the selection signal line SEL to a logic low level to release the selection of the pixel 11 connected to the row control line Vx. Accordingly, AD conversion of the row of the pixel 11 to which the row control line Vx of the pixel array 10 is connected ends.

FIG. 4 is a diagram for describing a binning mode, according to some example embodiments. In FIG. 4, a difference in color detected by each pixel 11 is shown in a different pattern. The pixels 11 of the same pattern may detect the same color. For example, each pixel 11 may detect one color from among red (R), green (G), and blue (B). However, a color detected by the pixel 11 is not limited to red (R), green (G), and blue (B).

In FIG. 4, a binning operation in which 16 (4×4) pixels 11 for detecting the same color are collected and regarded as one pixel is illustrated. A value (count value) of a pixel signal of a pixel 11B after binning may be counted as an average value of pixel signals of a plurality of pixels 11 before binning.

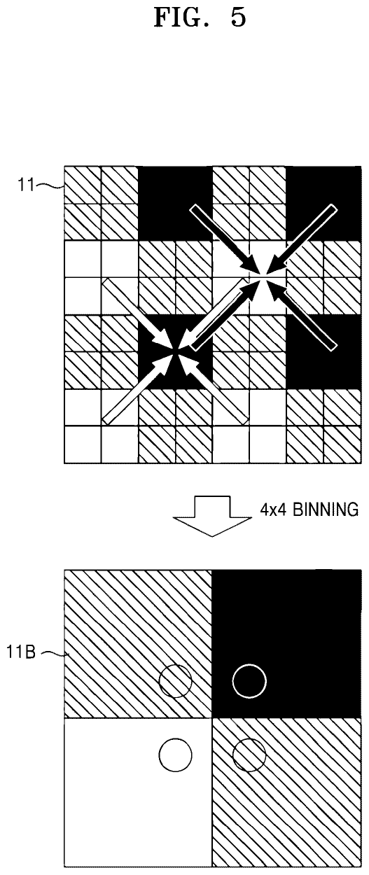

FIG. 5 is a diagram for describing a binning mode, according to some example embodiments. In FIG. 5, a difference in color detected by each pixel 11 is shown in a different pattern. The pixels 11 of the same pattern may detect the same color. For example, each pixel 11 may detect one color from among red (R), green (G), and blue (B). However, a color detected by the pixel 11 is not limited to red (R), green (G), and blue (B).

In FIG. 5, unlike in FIG. 4, 16 pixels for detecting the same color in the pixels 11 before binning are spaced apart from each other as four pixel blocks (each including 4 pixels 11). In this case, as marked by 4 thin arrows with the same color as a color detected by the pixels 11 to be binned, an average value of pixel signals of the pixels 11 constituting the four pixel blocks spaced apart from each other during binning may be counted.

However, in this case, the center of gravity (marked by a circle in FIG. 5) of a pixel 11B after binning may not match the center of gravity of the 16 pixels 11 before binning. Accordingly, the center of gravity may be misaligned according to the arrangement of the pixel 11B after binning. This misalignment in the center of gravity may be reduced by counting pixel signals of the pixels 11 before binning as a weighted average with a specific weight as described below.

For convenience of explanation, the following will be described assuming that binning is performed for every two pixels 11 in the same row. However, the inventive concepts are not limited thereto, and the number of pixels 11 to be binned may be three or more.

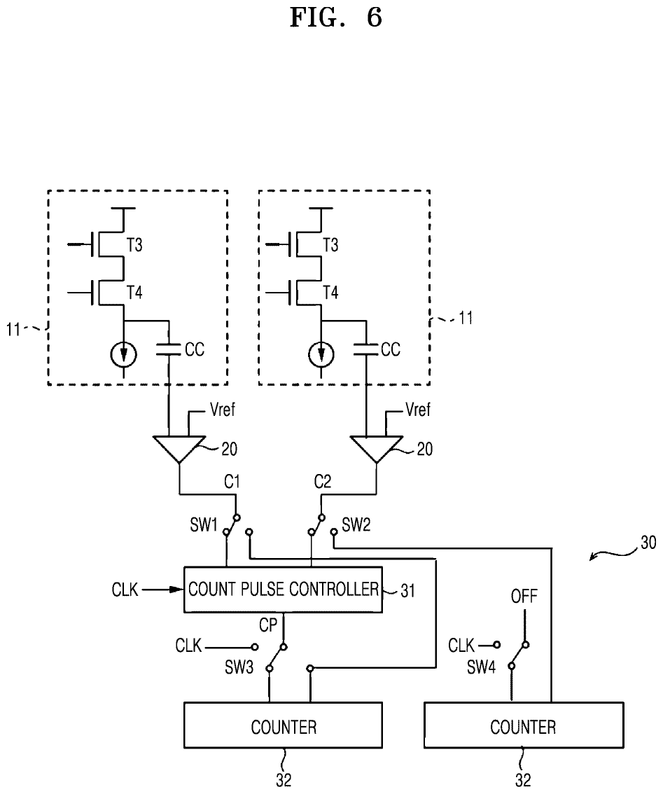

FIG. 6 is a diagram for describing the comparator 20 and the counter circuit unit 30, according to some example embodiments. In FIG. 6, a circuit of a part of the pixel 11 is also illustrated.

In a normal mode and a binning mode, a connection relationship between the comparator 20 and the count pulse controller 31 and the counter 32 of the counter circuit unit 30 may be switched by switches SW1 to SW4. In FIG. 6, a connection relationship between the comparator 20 and the count pulse controller 31 and the counter 32 of the counter circuit unit 30 in the binning mode is illustrated.

In the binning mode, the comparator 20, the count pulse controller 31, and one counter 32 are connected to each other in series. In the binning mode, the comparator 20 that outputs an output signal C1, the count pulse controller 31, and the counter 32 may be connected to each other through the switch SW1 and the switch SW3. In the binning mode, the comparator 20 that outputs an output signal C2, the count pulse controller 31, and the counter 32 may be connected to each other through the switch SW2 and the switch SW3. As described above, in the normal mode, the count pulse controller 31 may not operate. In the normal mode, each comparator 20 is connected to each counter 32. In the normal mode, the comparator 20 that outputs the output signal C1 may be directly connected to the counter 32 through the switch SW1. In the normal mode, the comparator 20 that outputs the output signal C2 may be directly connected to the counter 32 through the switch SW2. Also, the pixel 11 may include a DC blocking coupling capacitor CC between an input of the comparator 20 and a source follower circuit including the amplification transistor T3, for outputting a pixel signal.

Pixel signals output from the plurality of pixels 11 and the ramp signals Vref are input to the comparators 20, and the output signals C1 and C2 are output from the comparators 20.

The count pulse controller 31 generates and outputs a counter input signal CP from a clock signal CLK based on the output signals C1 and C2 of a plurality of comparators 20. Although the count pulse controller 31 receives the output signals C1 and C2 of two comparators 20 in FIG. 6, this is only an example and the count pulse controller 31 may receive output signals of a plurality of comparators 20. The counter input signal CP is a signal for counting an average value of two (multiple) pixel signals.

The counter 32 performs counting based on the counter input signal CP.

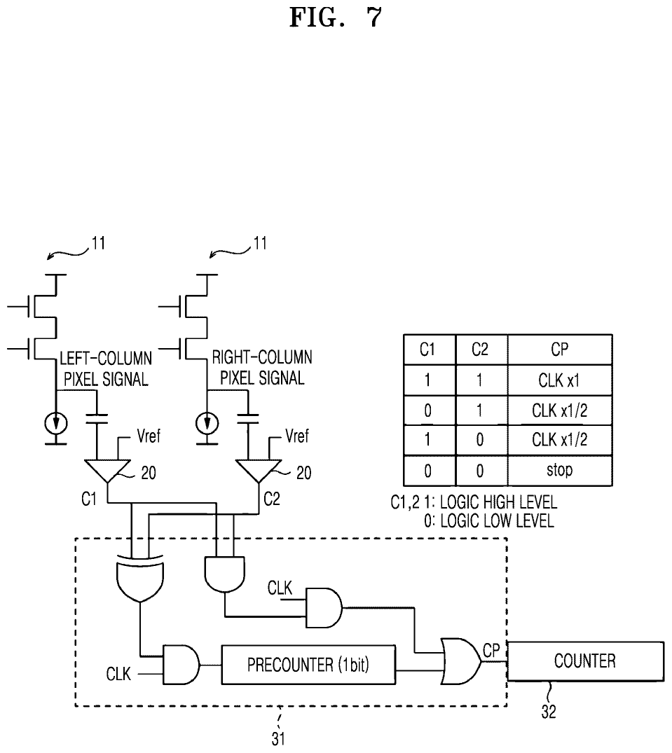

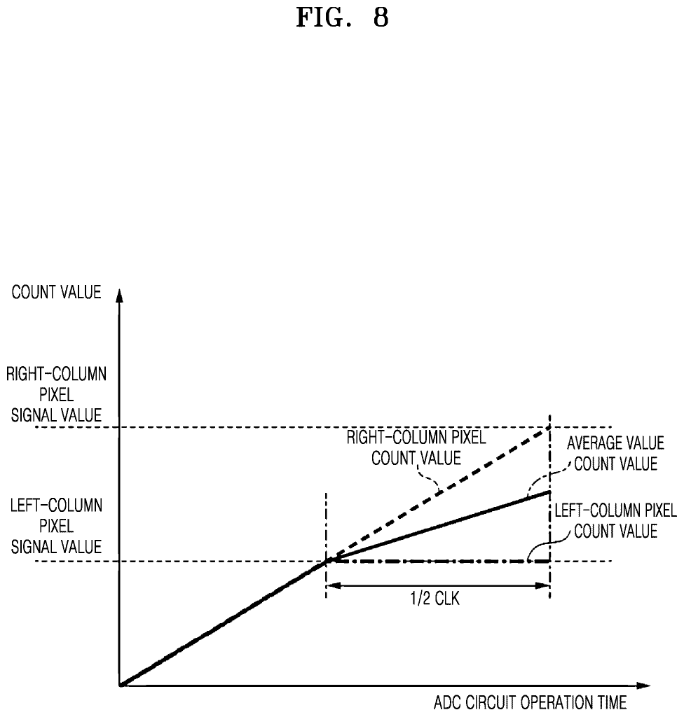

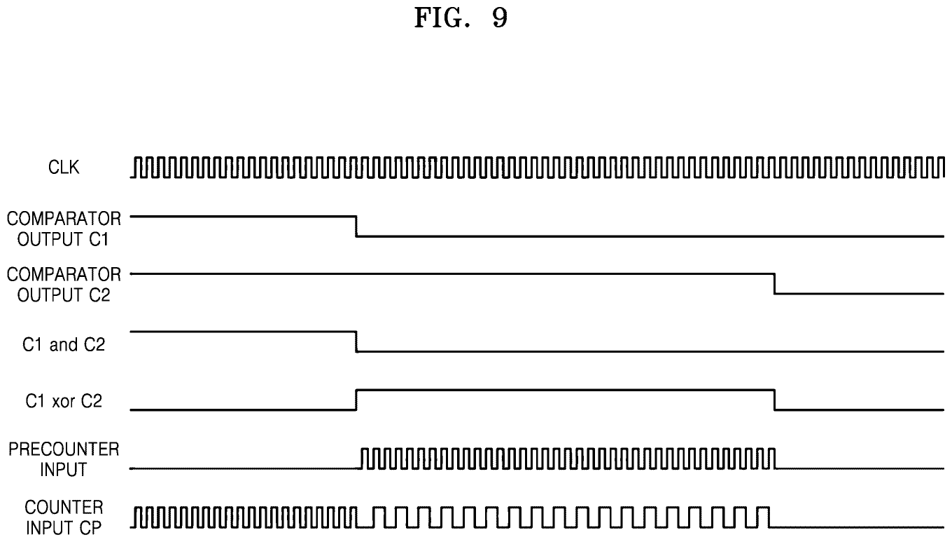

FIG. 7 is a diagram illustrating a configuration example of the count pulse controller 31 and a truth table, according to some example embodiments. In FIG. 7, a circuit of a part of the pixel 11, the comparator 20, and the counter 32 are also illustrated. FIG. 8 is a graph showing a relationship between an operation time of the ADC circuit 25 and a count value by the counter 32, according to some example embodiments. FIG. 9 is a diagram illustrating a timing chart of the count pulse controller 31 of FIG. 7, according to some example embodiments.

For convenience of explanation, the following will be described assuming that binning is performed for every two pixels 11 in the same row, but the inventive concepts are not limited thereto. Also, one of the two pixels 11 in the same row where binning is performed is referred to as a right-column pixel, and the other is referred to as a left-column pixel. For example, the left-column pixel signal may be referred to as a first pixel signal, and the right-column pixel signal may be referred to as a second pixel signal.

In FIG. 7, the count pulse controller 31 may include an AND circuit, an OR circuit, an XOR circuit, and a precounter. Also, the count pulse controller 31 may include an arbitrary circuit capable of providing the truth table of FIG. 7. For example, in terms of layout area, a NAND circuit may be used rather than an AND circuit. A 1-bit precounter functions as a ½ divider.

The count pulse controller 31 outputs an internal CLK as a counter input signal CP until a ramp signal Vref and any one of a right-column pixel signal and a left-column pixel signal are the same. The count pulse controller 31 outputs a ½ divided clock signal CLK×½ until the other of the right-column pixel signal and the left-column pixel signal is the same as the ramp signal Vref after the ramp signal Vref and any one of the right-column pixel signal and the left-column pixel signal are the same. Accordingly, the counter input signal CP becomes a signal in which an average value of two (multiple) pixel signals is counted, and an average value of two (multiple) pixel signals is counted by the counter 32.

Referring to FIG. 8, a gradient of a count value by the counter 32 with respect to an operation time of the ADC circuit 25 changes before and after the ramp signal Vref and any one of the right-column pixel signal and the left-column pixel signal are the same. In FIG. 8, a horizontal axis may represent an operation time of the ADC circuit 25, and a vertical axis may represent a count value. Also, in FIG. 8, a relationship between an operation time of the ADC circuit 25 and a count value by the counter 32 when only the left-column pixel signal is counted is shown as a dashed-dotted line graph. Also, a relationship between an operation time of the ADC circuit 25 and a count value by the counter 32 when only the right-column pixel signal is counted is shown as a dotted line graph.

Referring to FIG. 9, when the ramp signal Vref and any one of the right-column pixel signal and the left-column pixel signal are the same, the clock signal CLK may be output as the counter input signal CP until an output signal of the comparator becomes a logic low level. For example, assuming that the left-column pixel signal from among the right-column pixel signal and the left-column pixel signal is the same as the ramp signal Vref first, the clock signal CLK is output as the counter input signal CP until the output signal C1 of the comparator becomes a logic low level. After the ramp signal Vref and a pixel signal one side are the same, the ½ divided clock signal CLK×½ may be output until a pixel signal on the other side is the same as the ramp signal Vref. For example, after the ramp signal Vref is the same as the left-column pixel signal, the ½ divided clock signal CLK×½ may be output until the right-column pixel signal is the same as the ramp signal Vref.

As described above, misalignment in the center of gravity according to the arrangement of a pixel after binning (e.g., the pixel 11B of FIG. 5) may be reduced by counting a weighted average of pixel signals of the pixels 11 before binning.

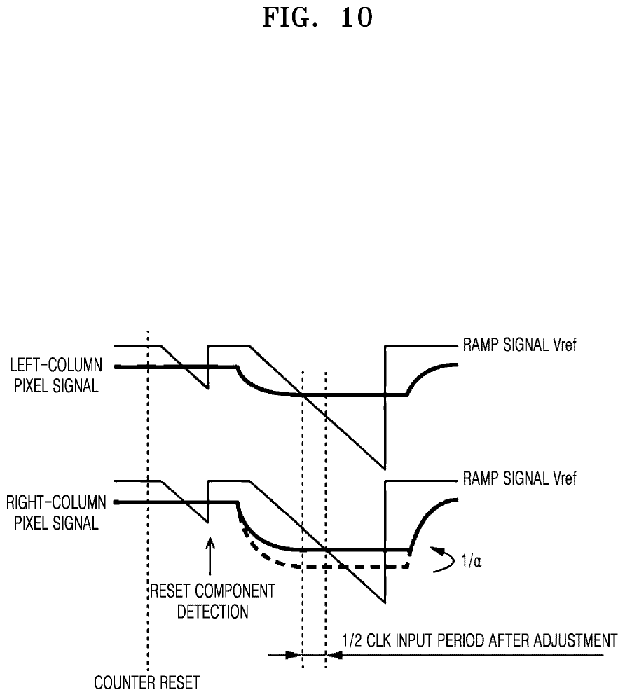

FIG. 10 is a diagram for describing an example of counting a weighted average value in binning, according to some example embodiments. The following will be described with reference to FIGS. 10 and 6 together. FIG. 10 illustrates a method of counting a weighted average value in binning by adjusting a ratio of two (multiple) coupling capacitors CC each connected to an input of each comparator 20.

In FIG. 10, thick solid lines indicate two (multiple) pixel signals (right-column pixel signal and left-column pixel signal) each input to each comparator 20 transmitted through the coupling capacitor CC. A solid line thinner than those of the pixel signals indicates a ramp signal Vref. A dashed line indicates the right-column pixel signal input to the comparator 20 before a ratio of the coupling capacitors is changed. A value of the coupling capacitor CC connected in series to an input of the comparator 20 to which the right-column pixel signal is input may be adjusted so that a size of the right-column pixel signal input to the comparator 20 is 1/60 before adjustment. Accordingly, a time at which a clock signal is input to the counter 32 may vary according to a value of α. For example, a time at which ½ CLK is input to the counter 32 may vary according to a value of α. As a count value by the counter 32 is adjusted, the count value may be an appropriate weighted average value.

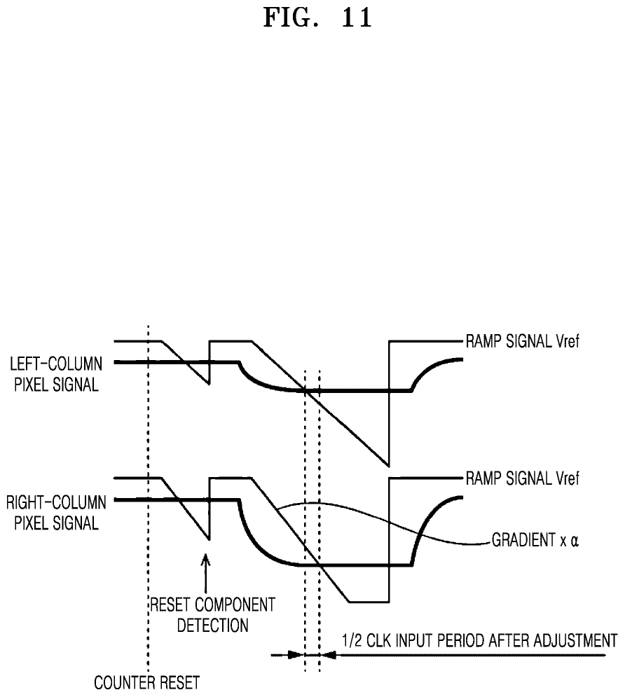

FIG. 11 is a diagram for describing some example embodiments of adjusting a gradient of a slope of the ramp signal Vref (hereinafter, referred to as a gradient of a ramp signal Vref), according to some example embodiments. The following will be described with reference to FIGS. 11 and 6 together. FIG. 11 illustrates a method of counting a weighted average value in binning by adjusting a gradient of a ramp signal Vref.

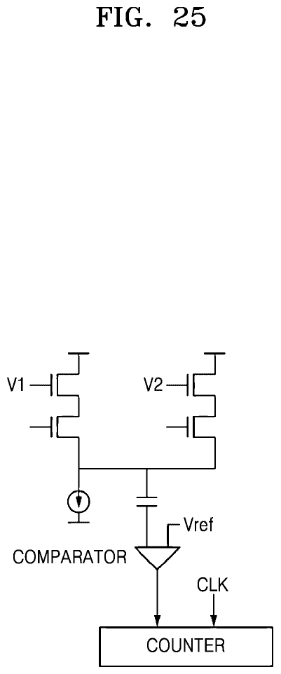

In FIG. 11, thick solid lines indicate two (multiple) pixel signals (right-column pixel signal and left-column pixel signal) each input to each comparator 20 transmitted through the coupling capacitor CC. A thin solid line indicates a ramp signal Vref. A gradient of the ramp signal Vref input to the comparator 20 to which the right-column pixel signal is input may be adjusted to be α times. For example, a gradient of the ramp signal Vref input to the comparator 20 to which the right-column pixel signal is input may be α times a gradient of the ramp signal Vref input to the comparator 20 to which the left-column pixel signal is input. Accordingly, a time at which a clock signal (e.g., ½ CLK) is input to the counter 32 may vary according to a value of α. As a count value by the counter 32 is adjusted, the count value may be an appropriate weighted average value. A comparative example will be described with reference to FIGS. 25 to 27.

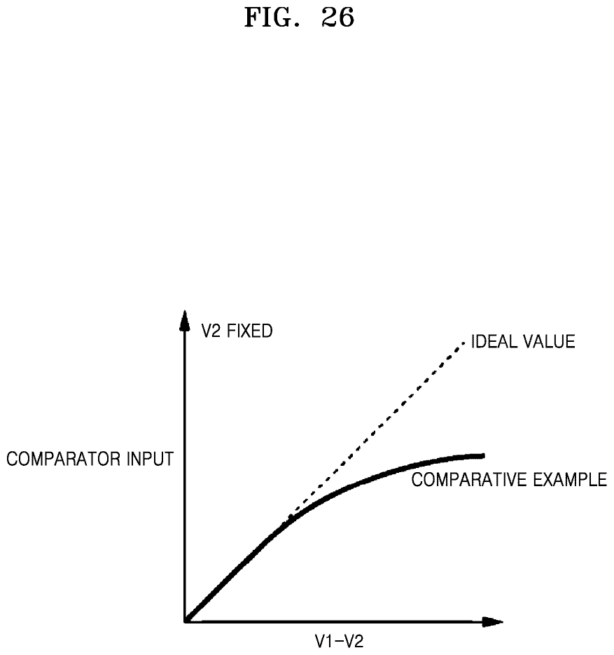

FIG. 25 is a diagram illustrating a configuration of an AD conversion circuit for counting an average value of pixel signals, according to a comparative example. FIG. 26 is a graph showing linearity characteristics in pixel signal addition, in the AD conversion circuit of FIG. 25.

As shown in FIG. 25, in the comparative example, analog signal addition in which signal lines of outputs of source followers to which input signals V1 and V2 are input are directly connected and thus analog signals are added is used. For example, signal lines of outputs of source followers to which the input signals V1 and V2 are input may be directly connected to one comparator. However, in this method, due to characteristics of source followers, a plurality of transistors of the source followers are connected in parallel and a current source is shared by a plurality of source followers. Accordingly, current concentrates on a transistor having a higher input voltage from among the plurality of transistors connected in parallel, and current flowing through other transistors decreases. Accordingly, current of the source followers which should operate with constant current does not become constant, thereby failing to ensure linearity.

Referring to FIG. 26, a horizontal axis of FIG. 26 represents a difference between the input signal V1 and the input signal V2, and a vertical axis represents an input signal of a comparator. In the comparative example, it is found that as the difference between the input signal V1 and the input signal V2 increases, the input signal of the comparator deviates from an ideal value.

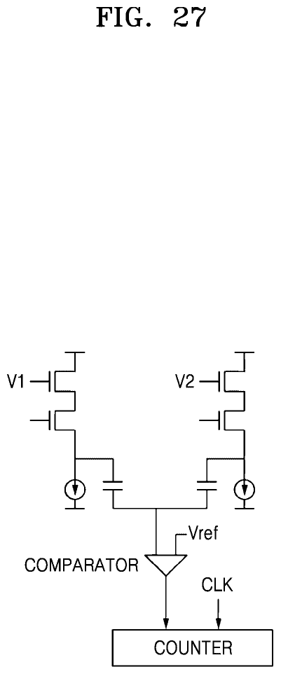

FIG. 27 is a diagram illustrating a configuration of an AD conversion circuit for counting an average value of pixel signals, according to another comparative example.

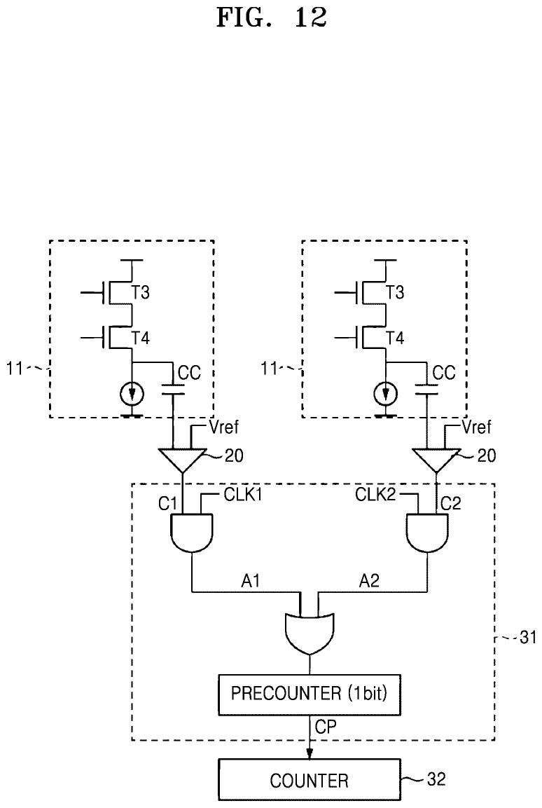

As shown in FIG. 27, in the comparative example, pixel signals of pixels may be input in parallel to an input of the AD conversion circuit. The input of the AD conversion circuit is connected to a signal line from each pixel through capacitive coupling. In the comparative example of FIG. 27, analog signal addition in which capacitors used for capacitive coupling are connected in parallel at the input of the AD conversion circuit and thus pixel signals are added and averaged as analog signals is used. In the comparative example, because a current source is provided for each source follower, linearity may be ensured. However, the number of signal lines connected to the input of the ADC circuit may increase. Also, the AD conversion circuit is provided in units of columns and laid out outside one side of a pixel array. Accordingly, the wiring of signal lines becomes long, a layout is complicated, and interference between signal lines is likely to occur. Embodiments may provide an AD conversion circuit for overcoming disadvantages of the comparative examples described with reference to FIGS. 25 to 27. Hereinafter, the AD conversion circuit according to some example embodiments will be described again with reference to FIG. 12.

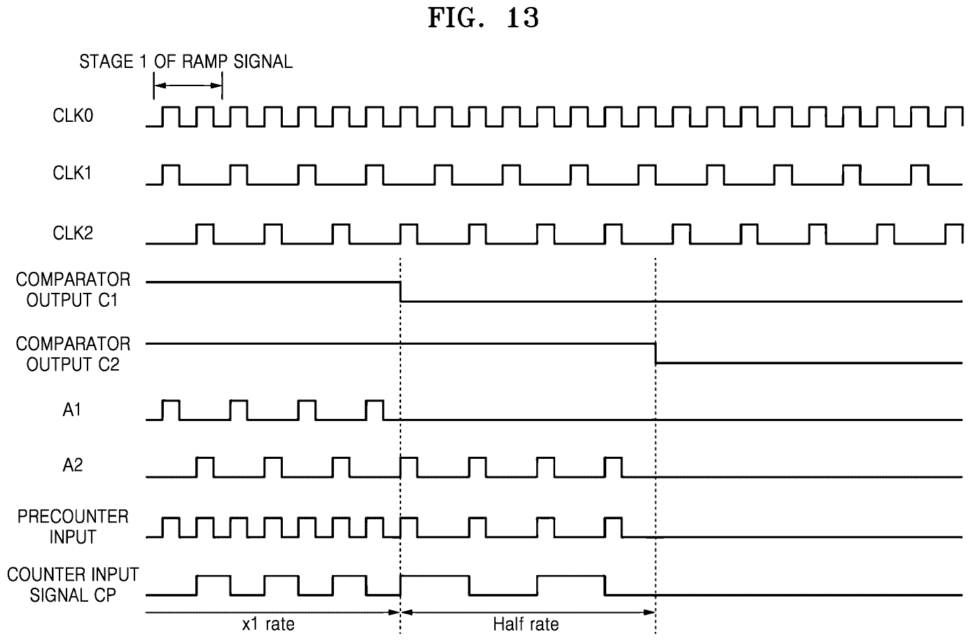

FIG. 12 is a diagram for describing the count pulse controller 31, according to some example embodiments. In FIG. 12, a circuit of a part of the pixel 11, the comparator 20, and the counter 32 are also illustrated. FIG. 13 is a diagram illustrating a timing chart of the count pulse controller 31 of FIG. 12. For convenience of explanation, one of two pixels 11 in the same row where binning is performed is referred to as a right-column pixel, and the other is referred to as a left-column pixel.

In a binning process, clock signals CLK1 and CLK2 for driving the count pulse controller 31 may be used. In FIG. 12, the count pulse controller 31 may use a plurality of clock signals CLK1 and CLK2 with different phases as the clock signals CLK1 and CLK2 for driving the count pulse controller 31. For example, compared to FIG. 7, the count pulse controller 31 of FIG. 7 may use one clock signal CLK for driving the count pulse controller 31. Hereinafter, a difference between FIG. 12 and FIG. 7 will be mainly described.

Referring to FIGS. 12 and 13, the count pulse controller 31 may include an AND circuit, an OR circuit, and a precounter. Also, the count pulse controller 31 may include an arbitrary circuit or the like. For example, to suppress an increase in layout area, a NAND circuit may be used, instead of an AND circuit. A 1-bit precounter functions as a ½ divider.

The count pulse controller 31 may receive two (multiple) types of clock signals CLK1 and CLK2 with different phases and may generate a counter input signal CP from the clock signals CLK1 and CLK2. Phases of the two clock signals CLK1 and CLK2 may be different from each other. For example, the two clock signals CLK1 and CLK2 may have a phase difference of 180°.

The clock signals CLK1 and CLK2 are generated by the driving control circuit 80 as clock signals synchronized with a clock signal CLK0 based on the clock signal CLK0. Two cycles of the clock signal CLK0 correspond to stage 1 of change of a ramp signal Vref (stage 1 of digital-analog (DA) conversion of the DAC circuit 70). Each comparator 20 may invert each of output signals C1 and C2 from a logic high level to a logic low level at a timing when the ramp signal Vref and each pixel signal (a right-column pixel signal or a left-column pixel signal) are the same.

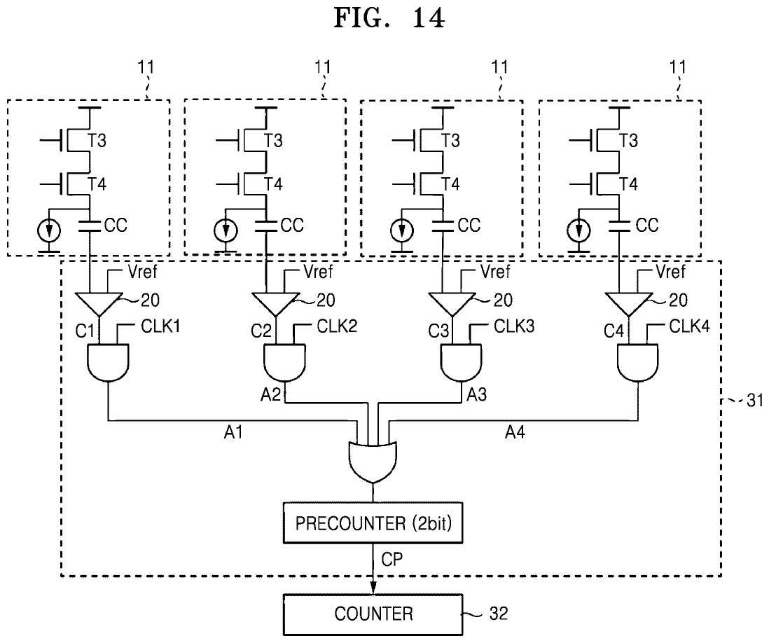

A signal obtained by merging the two clock signals CLK1 and CLK2 by using the OR circuit is input to the precounter until any one of the right-column pixel signal and the left-column pixel signal and the ramp signal Vref are the same. Any one of the two (multiple) clock signals CLK1 and CLK2 is input after any one pixel signal and the ramp signal Vref are the same. The signal input to the precounter is divided by the precounter and input to the counter 32. Accordingly, one cycle of the signal input to the counter 32 and the stage 1 of change of the ramp signal Vref match each other. The input signal CP divided by and output from the precounter may be counted by the counter 32. Although a method of binning pixel signals of two pixels 11 in the same row is illustrated in FIG. 12, the number of pixels 11 to be binned is not limited thereto. Hereinafter, a method of binning pixel signals of four pixels 11 in the same row will be described with reference to FIG. 14.

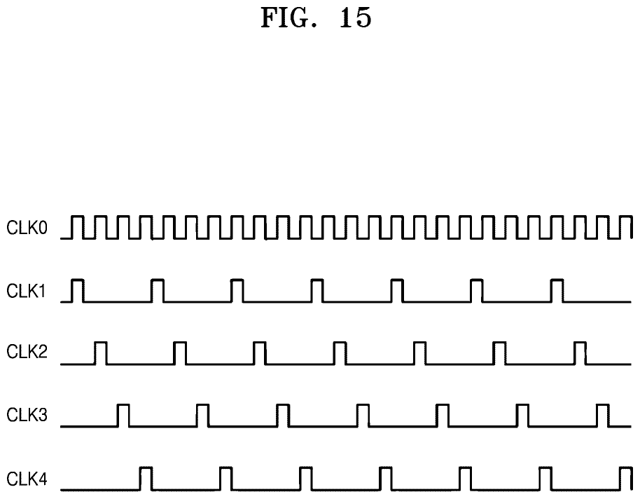

FIG. 14 is a diagram for describing the count pulse controller 31 for binning pixel signals of four pixels 11 in the same row, according to some example embodiments. FIG. 15 is a diagram illustrating a timing chart of four types of clock signals CLK1, CLK2, CLK3, and CLK4 input to the count pulse controller 31 of FIG. 14. The same description as that made above will be omitted.

Referring to FIG. 14, as described with reference to FIG. 12, the count pulse controller 31 may include an AND circuit, an OR circuit, and a precounter. The following will be described with reference to FIGS. 14 and 15 together.

The count pulse controller 31 may receive four (multiple) types of internal clock signals CLK1, CLK2, CLK3, and CLK4 with different phases and may generate a counter input signal CP from the clock signals CLK1, CLK2, CLK3, and CLK4. For example, the fourth clock signals CLK1, CLK2, CLK3, and CLK4 may have a phase difference of 90°. The clock signals CLK1, CLK2, CLK3, and CLK4 may be generated by the driving control circuit 80 as clock signals synchronized with a clock signal CLK0 based on the clock signal CLK0.

Four cycles of the clock signal CLK0 may correspond to stage 1 of change of a ramp signal Vref (stage 1 of DA conversion of the DAC circuit 70). Each comparator 20 may invert each of output signals C1, C2, C3, and C4 from a logic high level to a logic low level at a timing when the ramp signal Vref and each of four pixel signals are the same. For example, the comparator 20 connected to a leftmost pixel 11 may output the output signal C1 at a timing when the ramp signal Vref and a pixel signal of the leftmost pixel 11 are the same.

A signal obtained by merging the four (multiple) clock signals CLK1, CLK2, CLK3, and CLK4 by using the OR circuit is input to the precounter until any one pixel signal and the ramp signal Vref are the same. After any one pixel signal and the ramp signal Vref are the same, a signal obtained by merging the remaining three clock signals by using the OR circuit is input to the precounter. Next, a signal obtained as the number of merged clock signals decreases whenever another pixel signal and the ramp signal Vref are the same is input to the precounter. The signal input to the precounter is ¼ divided by the 2-bit precounter and input to the counter 32. Accordingly, one cycle of the signal input to the counter 32 and the stage 1 of change of the ramp signal Vref match each other. The input signal CP divided by and output from the precounter is counted by the counter 32.

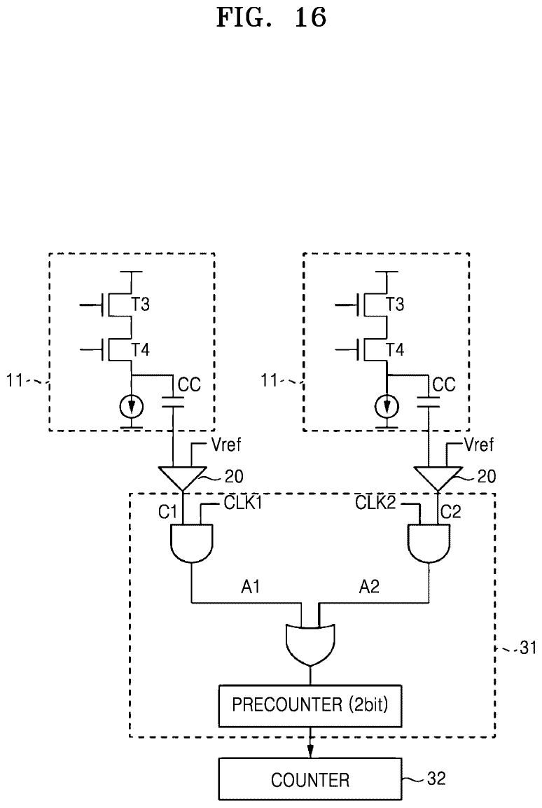

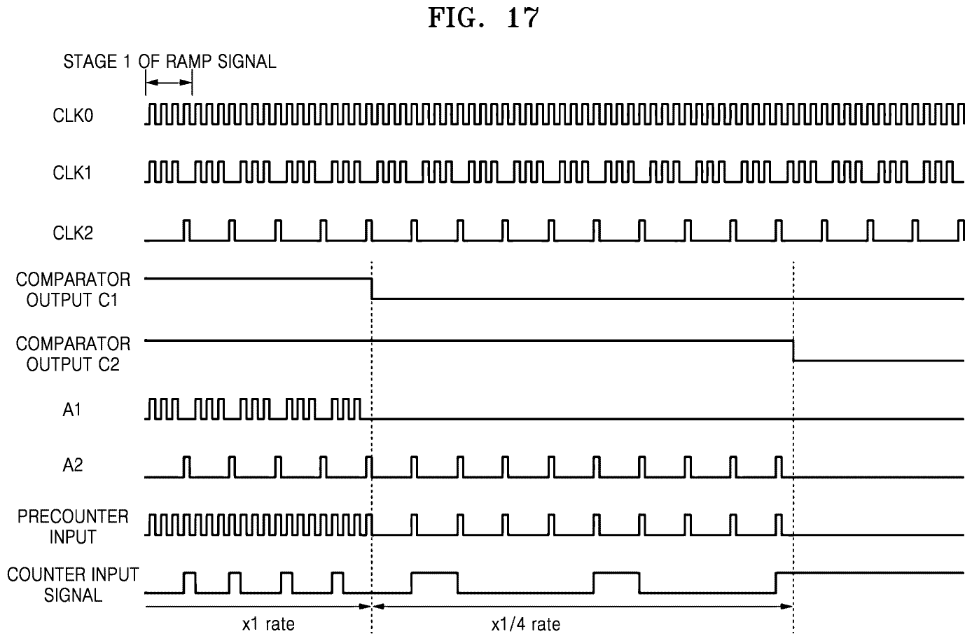

FIG. 16 is a diagram illustrating a configuration of the count pulse controller 31 for binning pixel signals of two pixels 11 in the same row, according to some example embodiments. FIG. 17 is a diagram illustrating a timing chart of the count pulse controller 31 of FIG. 16. Comparing FIGS. 12 and 16, FIG. 12 illustrates the count pulse controller 31 that performs binning by counting an average value of pixel signals of two pixels 11 in the same row whereas FIG. 16 illustrates the count pulse controller 31 that performs binning by counting a weighted average value of pixel signals of two pixels 11 in the same row. The following will be described with reference to FIGS. 16 and 17 together.

In FIG. 16, the count pulse controller 31 may include an AND circuit, an OR circuit, and a precounter. The precounter of the count pulse controller 31 of FIG. 16 may be a 2-bit precounter.

The count pulse controller 31 may receive two (multi) types of clock signals CLK1 and CLK2 with different phases and different numbers of clocks included in one cycle and may generate a counter input signal CP′ from the clock signals CLK1 and CLK2. Phases of the two clock signals CLK1 and CLK2 may be different from each other. For example, the two clock signals CLK1 and CLK2 may have a phase difference of 270°. The number of clocks included in one cycle may be different between the two clock signals CLK1 and CLK2. For example, the number of clocks included in one cycle of the clock signal CLK1 may be 3, and the number of clocks included in one cycle of the clock signal CLK2 may be 1. However, this is only an example, and the inventive concepts are not limited thereto.

The clock signals CLK1 and CLK2 are generated by the driving control circuit 80 as clock signals synchronized with a clock signal CLK0 based on the clock signal CLK0. Four cycles of the clock signal CLK0 may correspond to stage 1 of change of a ramp signal Vref (stage 1 of DA conversion of the DAC circuit 70). Each comparator 20 may invert each of output signals C1 and C2 from a logic high level to a logic low level at a timing when the ramp signal Vref and each of two (multiple) pixel signals are the same.

A signal obtained by merging the two (multiple) clock signals CLK1 and CLK2 by using the OR circuit is input to the precounter until any one of a left-column pixel signal and a right-column pixel signal and the ramp signal Vref are the same. After any one pixel signal and the ramp signal Vref are the same, any one clock signal CLK1 or CLK2 where an AND operation is performed by the AND circuit with the other pixel signal is input to the precounter. The signal input to the precounter is ¼ divided by the 2-bit precounter and input to the counter 32. Accordingly, one cycle of the signal input to the counter 32 and the stage 1 of change of the ramp signal Vref match each other. The input signal CP divided by and output from the precounter is counted by the counter 32.

In FIG. 16, it is assumed that the number of clocks included in one cycle of the clock signal CLK1 is 3 and the number of clocks included in one cycle of the clock signal CLK2 is 1. Accordingly, the left-column pixel signal may be counted by assigning a weight of ¾ and the right-column pixel signal may be counted by assigning a weight of ¼. Accordingly, binning is performed by counting a weighted average value of pixel signals of two pixels 11 in the same row. A count value by the counter 32 may be an appropriate weighted average value by adjusting the number of clocks included in each of the clock signals CLK1 and CLK2.

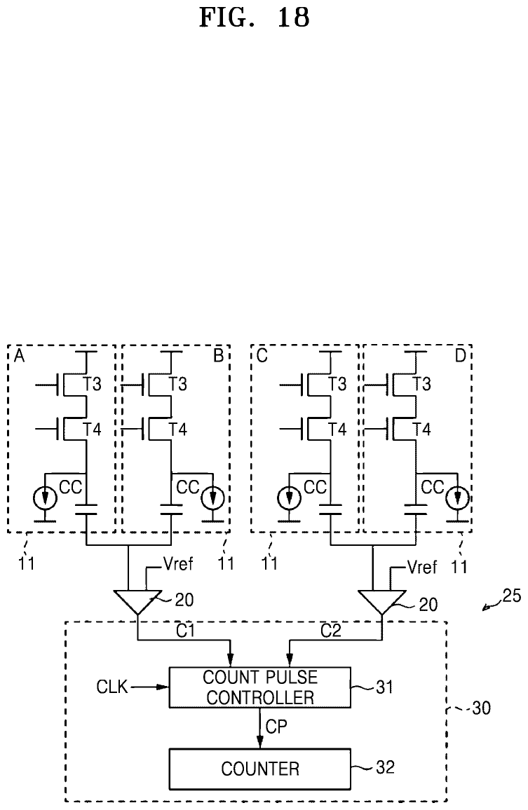

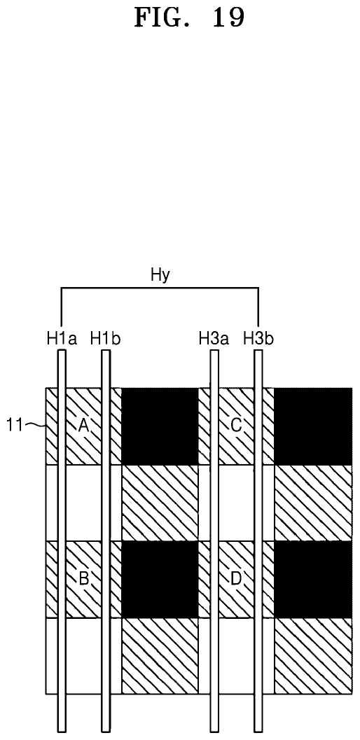

FIG. 18 is a diagram illustrating a configuration of the comparator 20 and the counter circuit unit 30, according to some example embodiments. In FIG. 18, a binning operation of counting an average value of pixel signals of a plurality of pixels 11 including pixels 11 in different rows will be described. For example, compared to FIG. 7, FIG. 7 illustrates a binning operation of counting an average value of pixel signals of two (multiple) pixels 11 in the same row. FIG. 19 is a diagram illustrating a part of the pixel array 10, according to some example embodiments. The following will be described with reference to FIGS. 18 and 19.

FIG. 18 illustrates the comparator 20, the counter circuit unit 30, and a circuit of a part of the pixel 11. In FIG. 19, a difference in color detected by each pixel 11 is shown in a different pattern. The pixels 11 of the same pattern may detect the same color. For example, each pixel 11 may detect one color from among red (R), green (G), and blue (B). However, a color detected by the pixel 11 is not limited to red (R), green (G), and blue (B).

For convenience of explanation, the following will be described assuming that two pixels 11 (pixel A and pixel C) in one row and two pixels 11 (pixel B and pixel D) in another row are binned. For example, the pixel A and the pixel C may be included in the same row, and the pixel B and the pixel D may be included in the same row. As shown in FIG. 19, the pixel A, the pixel B, the pixel C, and the pixel D are pixels 11 for detecting the same color. The number of pixels 11 to be binned is not limited to 4, and the number of pixels 11 to be binned may be 5 or more.

As shown in FIG. 18, outputs of the pixel A and the pixel B are connected in parallel to the comparator 20 on one side of the ADC circuit 25 through the coupling capacitors CC. Accordingly, because the coupling capacitors CC are connected in parallel at an input of the ADC circuit 25, pixel signals of the pixel A and the pixel B are added and averaged as analog signals and input to the comparator 20 on the one side of the ADC circuit 25. Likewise, outputs of the pixel C and the pixel D are connected in parallel to the comparator 20 on the other side of the ADC circuit 25 through the coupling capacitors CC. Accordingly, when the coupling capacitors CC are connected in parallel at the input of the ADC circuit 25, pixel signals of the pixel C and the pixel D are added and averaged as analog signals and input to the comparator 20 on the other side of the ADC circuit 25.

To simultaneously read pixel signals from the plurality of pixels 11 in the same column, two signal lines Hy are provided for each column of the pixel array 10. That is, a plurality of pixels 11 in the same column are connected to a plurality of read signal lines (column signal lines Hy), and a plurality of pixel signals are simultaneously output through the plurality of read signal lines. For example, the pixel A and the pixel B may be arranged in different rows and the same column, and the pixel A and the pixel B in the same column may be respectively connected to column signal lines H1a and H1b provided in the column. Also, because the pixel A and the pixel B are pixels 11 in different rows, the pixel A and the pixel B may be respectively connected to two different row signal lines (e.g., the row control lines Vx of FIG. 2), but the pixel A and the pixel B may be selected as pixels 11 for simultaneously reading pixel signals by a control signal transmitted to the two row control lines Vx to simultaneously read pixel signals from the pixel A and the pixel B. Likewise, the pixel C and the pixel D may be arranged in different rows and the same column, and the pixel C and the pixel D in the same column are respectively connected to two column signal lines H3a and H3b provided in the column. Also, because the pixel C and the pixel D are pixels 11 in different rows, the pixel C and the pixel D are respectively connected to two different row control lines Vx, but the pixel C and the pixel D are selected as pixels 11 for simultaneously reading pixel signals by a control signal transmitted to the two row control lines Vx to simultaneously read pixel signals from the pixel C and the pixel D. Accordingly, pixel signals are simultaneously read from the pixel A to the pixel D. The row control line Vx constitutes a scanning signal line.

The count pulse controller 31 generates a counter input signal CP in which an average value of pixel signals of the four (multiple) pixels 11 (the pixels A to D) is counted based on output signals C1 and C2 of the comparator 20.

The counter 32 may count an average value of pixel signals of the four (multiple) pixels 11 (the pixels A to D) based on the counter input signal CP.

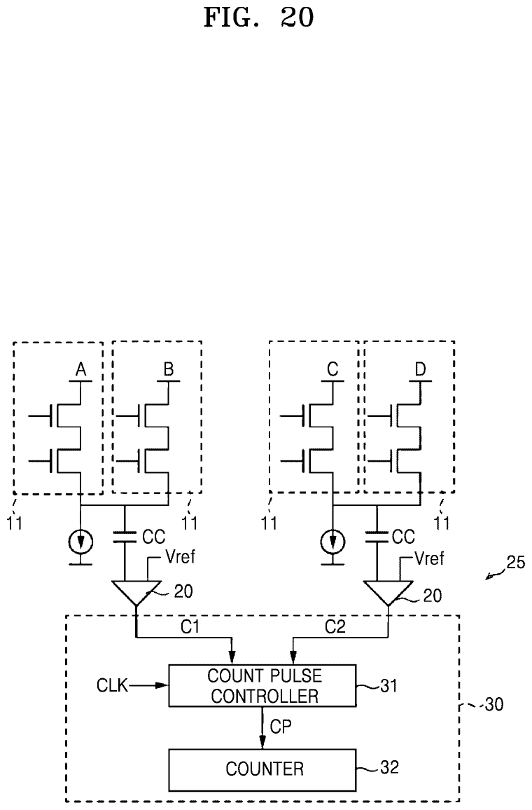

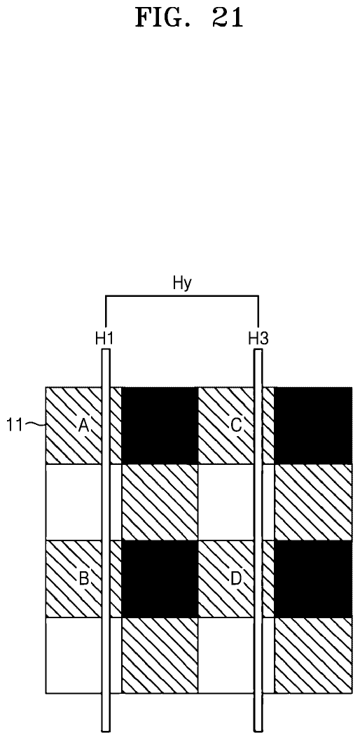

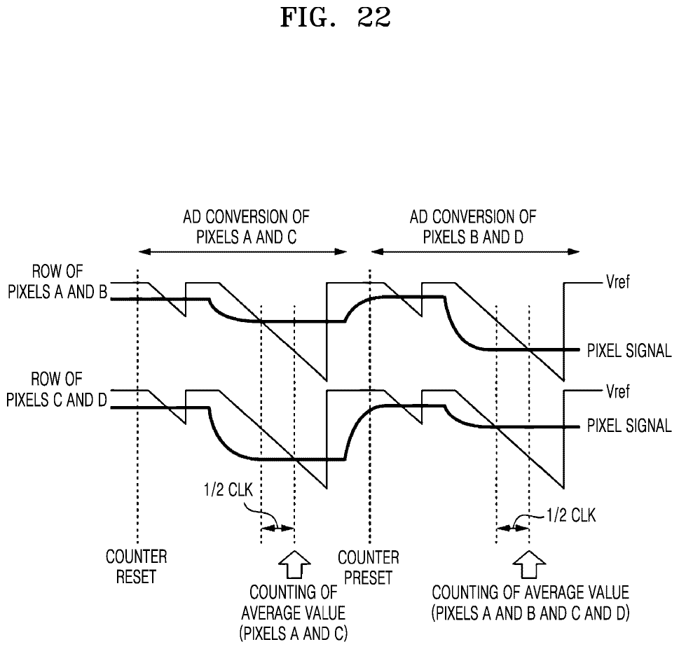

FIG. 20 is a diagram illustrating a configuration of the comparator 20 and the counter circuit unit 30, according to some example embodiments. FIG. 21 is a diagram illustrating a part of the pixel array 10, according to some example embodiments. FIG. 22 is a diagram for describing a read timing of a pixel signal, according to some example embodiments. Comparing FIGS. 18 and 20, FIG. 18 illustrates that two column signal lines Hy are provided for each column of the pixel array 10 and a binning operation of counting an average value of pixel signals of a plurality of pixels 11 including the pixels 11 in different rows is performed through one AD conversion, and FIG. 20 illustrates that one column signal line Hy is provided for each column of the pixel array 10 and a binning operation of counting an average value of pixel signals of a plurality of pixels 11 including the pixels 11 in different rows is performed through two AD conversions. The following will be described with reference to FIGS. 20, 21, and 22 together.

FIG. 20 illustrates the comparator 20, the counter circuit unit 30, and a circuit of a part of the pixel 11. In FIG. 21, a difference in color detected by each pixel 11 is shown in a different pattern. FIG. 22 illustrates a timing of reading pixel signals of two (multiple) pixels 11 in one row and counting an average value, and a timing of reading pixel signals of two (multiple) pixels 11 in different rows and counting an average value of the four (multiple) pixels 11.

For convenience of explanation, the following will be described assuming that two pixels 11 (pixel A and pixel C) in one row and two pixels 11 (pixel B and pixel D) in another row are binned. As shown in FIG. 21, the pixel A, the pixel B, the pixel C, and the pixel D are pixels 11 for detecting the same color. The number of pixels 11 to be binned is not limited to 4, and the number of pixels 11 to be binned may be 5 or more.

As shown in FIG. 20, outputs by source followers of the pixel A and the pixel B are connected to each other to be connected to the comparator 20 on one side of the ADC circuit 25 through the coupling capacitor CC. Likewise, outputs of source followers of the pixel C and the pixel D are connected to each other to be connected to the comparator 20 on the other side of the ADC circuit 25 through the coupling capacitor CC.

As shown in FIG. 21, one column signal line Hy is provided for each column of the pixel array 10. That is, a plurality of pixels 11 in the same column are connected to one read signal line (column signal line Hy), and a pixel signal is output through one read signal line for each pixel 11 of the column. For example, as shown in FIG. 21, the pixel A and the pixel B in the same column are respectively connected to one column signal line H1 provided in the column. Also, to read pixel signals from the pixel A and the pixel B, the pixel A and the pixel B are selected as pixels 11 for reading pixel signals at different timings by a control signal transmitted to signal lines in different rows (e.g., the row control lines Vx of FIG. 2).

Likewise, the pixel C and the pixel D in the same column are connected to one column signal line H3 provided in the column. Also, to read pixel signals from the pixel C and the pixel D, the pixel C and the pixel D are selected as pixels 11 for reading pixel signals at different timings by a control signal transmitted to the row control lines Vx in different rows. For example, a pixel signal of the pixel A may be read, and then a pixel signal of the pixel B may be read. A pixel signal of the pixel C may be read, and then a pixel signal of the pixel D may be read. The pixel A and the pixel C in the same row may simultaneously output pixel signals. Accordingly, pixel signals are simultaneously read from the pixel A and the pixel C, and then pixel signals are simultaneously read from the pixel B and the pixel D.

The count pulse controller 31 generates a counter input signal CP in which an average value of pixel signals of two (multiple) pixels 11 (the pixel A and the pixel C) in one row is counted based on output signals C1 and C2 of the comparator 20. Next, the count pulse controller 31 generates a counter input signal CP in which an average value of pixel signals of two (multiple) pixels 11 (the pixel B and the pixel D) in another row is counted based on the output signals C1 and C2 of the comparator 20.

The counter 32 counts an average value (hereinafter, referred to as “first average value”) of pixel signals of two (multiple) pixels 11 (the pixel A and the pixel C) in one row based on the counter input signal CP. Next, while mainlining a count value of the average value, the counter 32 counts an average value (hereinafter, referred to as “second average value”) of pixel signals of two (multiple) pixel signals 11 (the pixel B and the pixel D) in another row, to count a sum of the first average value and the second average value. Also, a 1-bit precounter may be provided as a divider in the count pulse controller 31 so that the counter 32 counts ½ of the sum of the first average value and the second average value. Accordingly, an average value of pixel signals of the four (multiple) pixels 11 may be counted by the counter 32.

As shown in an example of FIG. 22, in AD conversion of pixel signals of the pixel A and the pixel C for counting the first average value, the count pulse controller 31 outputs an internal clock CLK as the counter input signal CP until a ramp signal Vref and any one of pixel signals of the pixel A and the pixel C are the same. After the ramp signal Vref and any one of pixel signals of the pixel A and the pixel C are the same, the count pulse controller 31 outputs a ½ divided clock CLK×½ until the ramp signal and the other of the pixel signals of the pixel A and the pixel C are the same. Accordingly, the counter input signal CP becomes a signal in which an average value of pixel signals of the pixel A and the pixel C is counted, and an average value of pixel signals of the pixel A and the pixel Cis counted by the counter 32.

Next, in AD conversion of pixel signals of the pixel B and the pixel C for counting the second average value, the count pulse controller 31 outputs a clock signal CLK as the counter input signal CP until a ramp signal Vref and any one of pixel signals of the pixel B and the pixel D are the same. After the ramp signal Vref and any one of pixel signals of the pixel B and the pixel D are the same, the count pulse controller 31 outputs a ½ divided clock CLK×½ until the ramp signal and the other of the pixel signals of the pixel B and the pixel D are the same. Accordingly, the counter input signal CP becomes a signal in which an average value of pixel signals of the pixel B and the pixel D is counted, and an average value of pixel signals of the pixel B and the pixel D is counted by the counter 32.

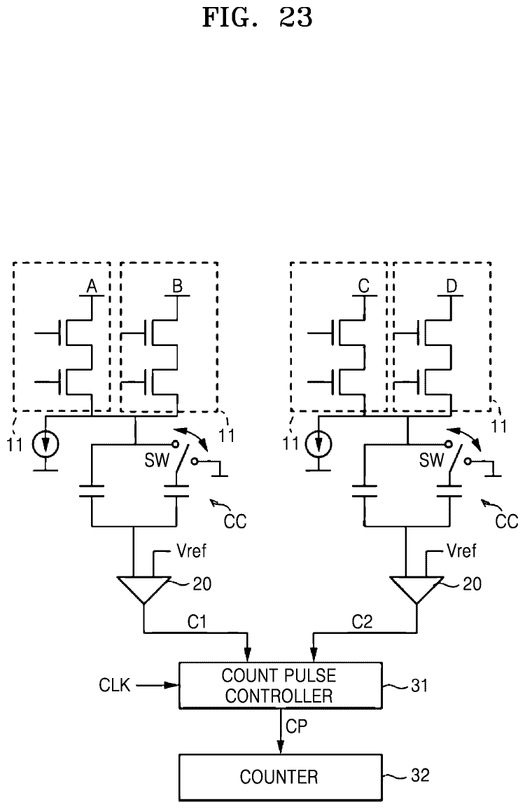

In FIG. 20, a binning operation of counting an average value of pixel signals of the plurality of pixels 11 is described. Some example embodiments of a binding operation of counting a weighted average value of pixel signals of the plurality of pixels 11 will be described with reference to FIG. 23.

FIG. 23 is a diagram illustrating a circuit configuration for performing binning of counting a weighted average value of pixel signals of the plurality of pixels 11, according to some example embodiments. The same description as that made above will be omitted.

Referring to FIG. 23, a capacitance value of the coupling capacitor CC provided between the comparator 20 and a connection point to which outputs by source followers of a pixel A and a pixel b are connected may be varied. Because a capacitance value of the coupling capacitor CC is varied, a weighted average value of pixel signals of the plurality of pixels 11 may be counted.

To vary a capacitance value of the coupling capacitor CC, the coupling capacitor CC may include a plurality of capacitive elements, and the number of capacitive elements connected in parallel may be changed by a switch SW. For example, a capacitance value of the coupling capacitor CC when a first average value is counted and a capacitance value of the coupling capacitor CC when a second average value is counted may be differently changed based on the switch SW. For example, a capacitance value of each coupling capacitor CC when the first average value is counted may be referred to as a first value, and a capacitance value of each coupling capacitor CC when the second average value is counted may be referred to as a second value different from the first value.

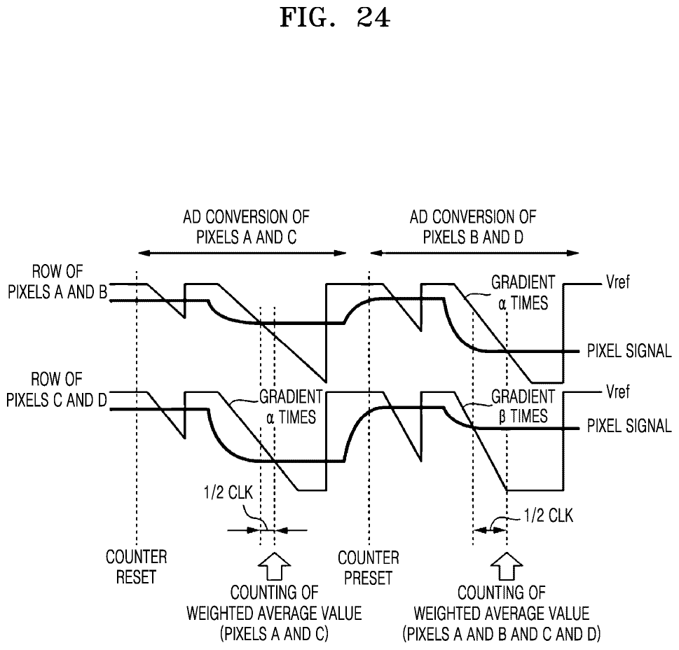

FIG. 23 illustrates a binning operation of counting a weighted average value of pixel signals of the plurality of pixels 11 by varying a capacitance value of the coupling capacitor CC. Hereinafter, some example embodiments of a binning operation of counting a weighted average value of pixel signals of the plurality of pixels 11 by changing a gradient of a ramp signal Vref will be described with reference to FIG. 24. FIG. 24 is a modified example of FIG. 22.

FIG. 24 is a diagram for describing a timing of reading pixel signals of the pixels 11 and counting an average value, according to some example embodiments. In detail, FIG. 24 is a diagram for describing a timing of reading pixel signals of two (multiple) pixels 11 in one row and counting an average value, and a timing of reading pixel signals of two (multiple) pixels 11 in different rows and counting an average value of the four (multiple) pixels 11. Also, a comparator, a counter circuit unit, and a pixel array described with reference to FIG. 24 respectively correspond to the comparator 20, the counter circuit unit 30, and the pixel array 10 of FIG. 20, and thus, a repeated description thereof will be omitted. The following will be described with reference to FIGS. 20 and 24 together.

As shown in FIG. 24, a gradient of a ramp signal Vref with which a pixel signal of the pixel C is compared by the comparator 20 may be α times a gradient of a ramp signal Vref with which a pixel signal of the pixel A is compared. A gradient of a ramp signal Vref with which a pixel signal of the pixel B is compared by the comparator 20 may be α times a gradient of a ramp signal Vref with which a pixel signal of the pixel A is compared. A gradient of a ramp signal Vref with which a pixel signal of the pixel D is compared by the comparator 20 may be β times a gradient of a ramp signal Vref with which a pixel signal of the pixel A is compared.

Based on a gradient of the ramp signal Vref with which a pixel signal of the pixel A is compared by the comparator 20, a gradient of the ramp signal Vref with which a pixel signal of the pixel B is compared may be α times a gradient of the ramp signal Vref with which a pixel signal of the pixel A is compared, a gradient of the ramp signal Vref with which a pixel signal of the pixel C is compared may be α times a gradient of the ramp signal Vref with which a pixel signal of the pixel A is compared, and a gradient of the ramp signal Vref with which a pixel signal of the pixel D is compared may be β times a gradient of the ramp signal Vref with which a pixel signal of the pixel A is compared. In counting of a weighted average value of pixel signals, a weight of 1/x times is assigned to a pixel signal of the pixel 11 compared with the ramp signal Vref by multiplying a gradient of the ramp signal Vref by x. Accordingly, in some example embodiments of FIG. 24, weights of 1 time, 1/α times, 1/α times, and 1/β times are respectively assigned to pixel signals of the pixel A, the pixel B, the pixel C, and the pixel D.

The counter 32 counts a weighted average value (hereinafter, referred to as a “first weighted average value”) of pixel signals of two (multiple) pixels 11 (the pixel A and the pixel C) in one row based on a counter input signal CP. Also, the counter 32 counts a weighted average value (hereinafter, referred to as a “second weighted average value”) of pixel signals of two (multiple) pixels 11 (the pixel B and the pixel D) in another row while maintaining a count value of the average value, to count a sum of the first weighted average value and the second weighted value. Also, a 1-bit precounter may be provided as a divider in the count pulse controller 31 so that the counter 32 counts ½ of the sum of the first weighted average value and the second weighted average value. Accordingly, a weighted average value of pixel signals of the four (multiple) pixels 11 may be counted by the counter 32.

As shown in FIG. 24, in AD conversion of pixel signals of the pixel A and the pixel C for counting the first weighted average value, the count pulse controller 31 outputs a clock signal CLK as the counter input signal CP until the ramp signal Vref and a pixel signal of the pixel A are the same. Next, the count pulse controller 31 outputs a ½ divided clock CLK×½ until the ramp signal Vref with a gradient that is multiplied by α and a pixel signal of the pixel C are the same. Accordingly, the counter input signal CP becomes a signal in which a weighted average value of pixel signals of the pixel A and the pixel C is counted, and a weighted average value of pixel signals of the pixel A and the pixel Cis counted by the counter 32.

Next, in AD conversion of pixel signals of the pixel B and the pixel D for counting the second weighted average value, the count pulse controller 31 generates a clock signal CLK as the counter input signal CP until the ramp signal Vref with a gradient that is multiplied by □ and a pixel signal of the pixel D are the same. Next, the count pulse controller 31 outputs a ½ divided clock CLK×½ until the ramp signal Vref with a gradient that is multiplied by α and a pixel signal of the pixel B are the same. Accordingly, the counter input signal CP becomes a signal in which a weighted average value of pixel signals of the pixel B and the pixel D is counted, and a weighted average value of pixel signals of the pixel B and the pixel D is counted by the counter 32.

Embodiments have the following effects.

A single-slope AD conversion circuit for performing AD conversion on a pixel signal includes a plurality of comparators configured to receive a plurality of pixel signals and a ramp signal, a count pulse controller configured to generate a counter input signal from a clock signal based on outputs of the plurality of comparators, and a counter configured to perform counting based on the counter input signal. Accordingly, binning of pixel signals may be performed with high precision while suppressing layout complexity, an increase in chip area, an increase in power consumption, and a decrease in processing speed.

Also, the count pulse controller generates a counter input signal for counting an average value or a weighted average value of a plurality of pixel signals. Accordingly, misalignment of a center of gravity due to binning may be suppressed while suppressing layout complexity, an increase in chip area, an increase in power consumption, and a decrease in processing speed.

Also, the count pulse controller includes a precounter of 1 bit or more. Accordingly, layout complexity, an increase in chip area, an increase in power consumption, and a decrease in processing speed may be further suppressed, while providing a binning function.

Also, the count pulse controller receives a plurality of types of clock signals with different phases and generates a counter input signal from the plurality of types of clock signals. Accordingly, binning of pixel signals may be performed with high precision while more flexibly suppressing layout complexity, an increase in chip area, an increase in power consumption, and a decrease in processing speed.

Also, the plurality of pixel signals are pixel signals simultaneously read from a plurality of pixels connected to the same scanning signal line. Accordingly, pixels to be binned may be flexibly and simply set.

Also, the plurality of pixel signals are pixel signals simultaneously read from a plurality of pixels connected to different scanning signal lines. Accordingly, pixels to be binned may be flexibly and simply set.

Also, the plurality of pixels arranged in the same column are respectively connected to a plurality of read signal lines, and a plurality of pixel signals are simultaneously output through the plurality of read signal lines. Accordingly, pixels to be binned may be flexibly and simply set, and an increase in time required to perform binning may be suppressed.

Also, the plurality of pixels arranged in the same column are connected to one read signal line, and a plurality of pixel signals are sequentially output through the one read signal line. Accordingly, pixels to be binned may be flexibly and more simply set.

Also, a plurality of coupling capacitors respectively connected to inputs of the plurality of comparators to which pixel signals are input are provided, and the count pulse controller generates a counter input signal for counting a weighted average value of a plurality of pixel signals, wherein weights are assigned to the pixel signals according to a ratio of capacitance values of the plurality of coupling capacitors, to assign a weight to a weighted average value. Accordingly, a weighted average value of a plurality of pixel signals may be counted with a simpler configuration.

Also, a ramp signal generator configured to generate a plurality of ramp signals whose slopes have different gradients and respectively input the plurality of ramp signals to a plurality of comparators is included, and the count pulse controller generates a counter input signal for counting a weighted average value of a plurality of pixel signals, wherein weights are assigned to the pixel signals according to gradients of the slopes of the plurality of ramp signals, to assign a weight to a weighted average value. Accordingly, a weighted average value of a plurality of pixel signals may be counted with a simpler configuration.

When the terms “about” or “substantially” are used in this specification in connection with a numerical value, it is intended that the associated numerical value includes a manufacturing or operational tolerance (e.g., ±10%) around the stated numerical value or time. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While the inventive concept has been particularly shown and described with reference to example embodiments, it will be understood that various changes in form and details may be made therein without departing from the spirit and scope of the inventive concepts. Accordingly, the example embodiments should be considered in descriptive sense only and not for purposes of limitation. Therefore, the inventive concepts are defined by the appended claims, and all differences within the scope will be construed as being included in the inventive concepts.

While the inventive concept has been particularly shown and described with reference to example embodiments thereof, it will be understood that various changes in form and details may be made therein without departing from the spirit and scope of the following claims.

What is claimed is:

1. An analog-digital (AD) conversion circuit for performing AD conversion on a pixel signal, the AD conversion circuit comprising:
a plurality of comparators configured to receive a plurality of pixel signals and a ramp signal;
a count pulse controller configured to generate a counter input signal for counting an average value or a weighted average value of the plurality of pixel signals from a clock signal, based on outputs of the plurality of comparators; and
a counter configured to count the average value or the weighted average value of the plurality of pixel signals based on the counter input signal.

2. The AD conversion circuit of claim 1, wherein the count pulse controller comprises a precounter of 1 bit or more.

3. The AD conversion circuit of claim 1, wherein the count pulse controller is further configured to generate a clock signal as a counter input signal until one of the plurality of pixel signals and the ramp signal are same and then divide the clock signal to generate the counter input signal.

4. The AD conversion circuit of claim 1, wherein
the plurality of comparators are further configured to receive the plurality of pixel signals with different coupling capacitors, and
the count pulse controller is further configured to generate the counter input signal for counting the weighted average value of the plurality of pixel signals based on comparison of the plurality of pixel signals with the different coupling capacitors and the ramp signal.

5. The AD conversion circuit of claim 1, wherein
the plurality of comparators are further configured to receive the plurality of pixel signals and a plurality of ramp signals whose slopes have different gradients, and
the count pulse controller is further configured to generate the counter input signal for counting the weighted average value of the plurality of pixel signals.

6. The AD conversion circuit of claim 1, wherein the count pulse controller is further configured to receive a plurality of types of clock signals with different phases and generate the counter input signal based on the plurality of types of clock signals.

7. The AD conversion circuit of claim 6, wherein the count pulse controller is further configured to generate the counter input signal based on a signal obtained by merging the plurality of types of clock signals with different phases, until one of the plurality of pixel signals and the ramp signal are same.

8. The AD conversion circuit of claim 6, wherein the plurality of types of clock signals have a same number of clocks included in one cycle and have different phases.

9. The AD conversion circuit of claim 6, wherein the plurality of types of clock signals have different numbers of clocks included in one cycle and have different phases.

10. The AD conversion circuit of claim 1, wherein the plurality of pixel signals are pixel signals simultaneously read from a plurality of pixels connected to a same row control line.

11. The AD conversion circuit of claim 1, wherein the plurality of pixel signals are pixel signals simultaneously read from a plurality of pixels connected to different row control lines.

12. The AD conversion circuit of claim 11, wherein the plurality of pixel signals are output, from a plurality of pixels arranged in a same column and respectively connected to a plurality of read signal lines, simultaneously through the plurality of read signal lines.

13. The AD conversion circuit of claim 11, wherein the plurality of pixel signals are output, from a plurality of pixels arranged in a same column and connected to one read signal line, sequentially through the one read signal line.

14. The AD conversion circuit of claim 1, further comprising a switch configured to control connection among the plurality of comparators, the count pulse controller, and the counter,
wherein, in a binning mode, at least one of the plurality of comparators, the count pulse controller, and the counter are connected to each other through the switch, and
in a normal mode, at least one of the plurality of comparators and the counter are connected to each other through the switch.

15. A solid-state imaging device comprising:
a plurality of comparators configured to receive a plurality of pixel signals and a ramp signal;
a count pulse controller configured to generate a counter input signal for counting an average value or a weighted average value of the plurality of pixel signals from a clock signal, based on outputs of the plurality of comparators;
a counter configured to count the average value or the weighted average value of the plurality of pixel signals based on the counter input signal; and
a plurality of coupling capacitors respectively connected to inputs of the plurality of comparators to which the plurality of pixel signals are input,
the count pulse controller further configured to
generate the counter input signal for counting the weighted average value of the plurality of pixel signals, and
assign weights to the plurality of pixel signals according to a ratio of capacitance values of the plurality of coupling capacitors to assign a weight to the weighted average value.

16. The solid-state imaging device of claim 15, wherein the count pulse controller is further configured to generate the clock signal as the counter input signal until a first pixel signal of a capacitance value of a first coupling capacitor from among the plurality of pixel signals and the ramp signal are same.

17. The solid-state imaging device of claim 16, wherein the count pulse controller is further configured to, after the first pixel signal and the ramp signal are the same, divide the clock signal until a second pixel signal of a capacitance value of a second coupling capacitor from among the plurality of pixel signals and the ramp signal are same to generate the counter input signal.

18. A solid-state imaging device comprising:
a plurality of comparators configured to receive a plurality of pixel signals and a ramp signal;
a count pulse controller configured to generate a counter input signal for counting an average value or a weighted average value of the plurality of pixel signals from a clock signal, based on outputs of the plurality of comparators;
a counter configured to count the average value or the weighted average value of the plurality of pixel signals based on the counter input signal; and
a ramp signal generator configured to generate a plurality of ramp signals with ramp signals whose slopes have different gradients and respectively input the plurality of ramp signals to the plurality of comparators,
the count pulse controller further configured to
generate the counter input signal for counting the weighted average value of the plurality of pixel signals, and
assign weights to the plurality of pixel signals according to gradients of the slopes of the plurality of ramp signals to assign a weight to the weighted average value.

19. The solid-state imaging device of claim 18, wherein the count pulse controller is further configured to generate the clock signal as the counter input signal until a first pixel signal from among the plurality of pixel signals and a ramp signal with a first gradient are same.

20. The solid-state imaging device of claim 19, wherein the count pulse controller is further configured to, after the first pixel signal and the ramp signal with the first gradient are the same, divide the clock signal until a second pixel signal from among the plurality of pixel signals and a ramp signal with a second gradient are same to generate the counter input signal.
